(19) United States
(12) Patent Application Publication
(10) Pub. No.: US 2021/0319080 A1
(43) Pub. Date: Oct. 14, 2021

(54) TENSOR DATA CALCULATING APPARATUS, TENSOR DATA CALCULATING METHOD AND PROGRAM

(71) Applicant: NIPPON TELEGRAPH AND TELEPHONE CORPORATION, Tokyo (JP)

(72) Inventors: Tatsushi MATSUBAYASHI, Musashino-shi, Tokyo (JP); Ryota IMAI, Musashino-shi, Tokyo (JP); Masahiro KOZIMA, Musashino-shi, Tokyo (JP); Hiroyuki TODA, Musashino-shi, Tokyo (JP)

(21) Appl. No.: 17/268,207

(22) PCT Filed: Jun. 21, 2019
(86) PCT No.: PCT/JP2019/024792

§ 371 Date: Feb. 12, 2021

(30) Foreign Application Priority Data
Aug. 16, 2018 (JP) 2018-153244

(51) Int. Cl. G06F 17/16

(52) U.S. Cl. CPC G06F 17/16

(57) ABSTRACT

Provided is a tensor data calculation device that includes a matrix product calculation processor and decomposes N-th order (N is an integer of 2 or more) non-negative tensor data into N factor matrices by factorization. The tensor data calculation device includes: a factorization means that represents update formulae of the factor matrices for optimizing a prescribed objective function value in a format that includes a matrix product of a first matrix obtained by expanding other N−1 factor matrices other than the factor matrices by a Kronecker product and a second matrix defined by a tensor product of the non-negative tensor data and the N factor matrices and calculate the update formulae; and a matrix calculation means that calculates the matrix products included in the update formulae with the aid of the matrix product calculation processor. The factorization means calculates the update formulae using calculation results of the matrix products calculated by the matrix calculation means.

### TECHNICAL FIELD

The present invention relates to a tensor data calculation device, a tensor data calculation method, and a program.

### BACKGROUND ART

Log data such as purchase logs and check-in logs can be generally represented as tensors. Since these pieces of log data are represented as positive real numbers, log data represented as tensors can be factor-analyzed using non-negative tensor factorization (NTF). For example, NPL 1 discloses a method of general non-negative tensor factorization.

An example in which several days of data indicating products purchased by users among a plurality of products are present for each user will be considered. In this example, these pieces of data can be represented as third-order tensor data (that is, tensor data having a mode number of 3) of “(user)×(product)×(day)”. When the tensor data is factorized into R (Rank) bases using I (number of users), J (number of products), and K (number of days), a calculation amount of the factorization is proportional to I×J×K×R. Therefore, for example, if I=1000, J=1000, K=1000, and R=100, non-negative tensor factorization of the tensor data requires a scale of 100 billion calculations.

A calculation example of non-negative tensor factorization will be described in more detail. In non-negative tensor factorization, tensor data is decomposed into tensor products of factor matrices while maintaining non-negativeness. For example, third-order tensor data X of “(number of users I)×(number of products J)×(number of days K)” can be decomposed into three factor matrices A, B, and C and can be represented as expression (1) below.

[Formula 1]

X≈\hat{X}=A∘B∘C (1)

In the text of the present specification, the hat “\hat{ }” which is a symbol representing an estimated amount is described immediately before a character rather than on the head of a character for the sake of convenience. For example, an estimated amount of X is represented as “\hat{ }X”. The factor matrices A, B, and C are non-negative matrices of I×R, J×R, and K×R, respectively. In the following description, the elements of X, A, B, C, and \hat{ }X will be represented as xᵢⱼₖ, aᵢᵣ, bⱼᵣ, cₖᵣ, and \hat{ }xᵢⱼₖ, respectively. xᵢⱼₖ, aᵢᵣ, bⱼᵣ, cₖᵣ, and \hat{ }xᵢⱼₖ are non-negative values.

In this case, the tensor product of the factor matrices A, B, and C is represented as the product of respective bases as in expression (2) below.

$$\begin{matrix}[ Formula 2 ] & \\ \hat{X} = A ∘ B ∘ C = {\hat{x}}_{𝔦 j k} = {\sum }_{r}^{R} {a}_{ir} {b}_{jr} {c}_{kr} & ( 2 )\end{matrix}$$

Tensor factorization is a method of obtaining the factor matrices A, B, and C so that the pieces of tensor data X and \hat{ }X become approximately equal. That is, tensor factorization obtains such factor matrices A, B, and C that minimize L(X|\hat{ }X) where L is a distance function (this distance function is an objective function of an optimization problem). When a generalized KL divergence (gKL) distance is used as the distance function L, the distance function L is represented as expression (3) below.

$$\begin{matrix}[ Formula 3 ] & \\ L ( X \vert \hat{X} ) = {\sum }_{i}^{I} {\sum }_{j}^{J} {\sum }_{k}^{K} \{ {x}_{i j k} log \frac{{x}_{i j k}}{{\hat{x}}_{i j k}} - {x}_{i j k} + {\hat{x}}_{i j k} \} & ( 3 )\end{matrix}$$

In this case, the update formulae of A, B, and C are represented as expressions (4) to (6) below.

$$\begin{matrix}[ Formula 4 ] \\ & \\ {a}_{ir} := {a}_{ir} \times \frac{{\sum }_{j}^{J} {\sum }_{k}^{K} \frac{{x}_{i j k}}{{\hat{x}}_{i j k}} {b}_{jr} {c}_{k r}}{{\sum }_{j}^{J} {\sum }_{k}^{K} {b}_{jr} {c}_{k r}} & ( 4 ) \\ {b}_{j r} := {b}_{j r} \times \frac{{\sum }_{i}^{I} {\sum }_{k}^{K} \frac{{x}_{i j k}}{{\hat{x}}_{i j k}} {a}_{i r} {c}_{k r}}{{\sum }_{i}^{I} {\sum }_{k}^{K} {a}_{i r} {c}_{k r}} & ( 5 ) \\ {c}_{kr} := {c}_{kr} \times \frac{{\sum }_{i}^{I} {\sum }_{j}^{J} \frac{{x}_{i j k}}{{\hat{x}}_{i j k}} {a}_{ir} {b}_{jr}}{{\sum }_{i}^{I} {\sum }_{j}^{J} {a}_{ir} {b}_{jr}} & ( 6 )\end{matrix}$$

The update formula of \hat{ }X is represented as expression (7) below.

$$\begin{matrix}[ Formula 5 ] & \\ {\hat{x}}_{ijk} = {\sum }_{r}^{R} {a}_{ir} {b}_{jr} {c}_{kr} & ( 7 )\end{matrix}$$

A, B, and C after factorization are obtained by initializing aᵢᵣ, bⱼᵣ, and cₖᵣ to appropriate values and repeatedly applying the update formulae of expressions (4) to (7) several times according to an arbitrary optimization algorithm.

In this case, when the update formula of aᵢᵣ illustrated in expression (4) is executed as program processing, it is necessary to execute J×K times of loop processing for obtaining the value of aᵢᵣ with respect to each of (I×R) aᵢᵣ. Therefore, it is necessary to execute I×J×K×R times of loop processing finally. Moreover, it is necessary to execute the same times of loop processing for the update formulae of \hat{ }xᵢⱼₖ, bⱼᵣ, and cₖᵣ.

However, in recent years, methods using a graphics processing unit (GPU) in numerical calculation have become widespread mainly in deep learning. Deep learning involves a lot of processing that performs matrix product calculation and the calculation amount is an issue. For example, a calculation amount of the product of N×N square matrices is proportional to N×N×N. In contrast, a GPU is good at simple parallel processing and can perform matrix product calculation or the like at a high speed. By calculating the matrix product using a GPU, it is possible to accelerate processing 100 times or more as compared to a central processing unit (CPU). Moreover, GPUs having a dedicated chip (or processor) specialized for matrix product calculation incorporated therein are also known, and processing can be further accelerated 10 times or more using the GPUs. In the following description, a dedicated chip (or processor) specialized for matrix product calculation is also referred to as a “matrix product dedicated processor”.

### CITATION LIST

### Non Patent Literature

[NPL 1] Liu, Weixiang, Tianfu Wang, and Siping Chen, “Non-negative tensor factorization for clustering genes with time series microarrays from different conditions: A case study,” Biomedical Engineering and Informatics (BMEI), 2010 3rd International Conference on Vol. 6, IEEE, 2010.

### SUMMARY OF THE INVENTION

### Technical Problem

However, as illustrated in expressions (4) to (7), for example, the update formula of a factor matrix is represented as a tensor product. Therefore, it is not possible to calculate the update formula of a factor matrix directly using the GPU having a matrix product dedicated processor incorporated therein.

In contrast, if a tensor product in the update formula of a factor matrix can be represented as a matrix product, it is possible to calculate the update formula of a factor matrix using the GPU having the matrix product dedicated processor incorporated therein and to accelerate processing related to non-negative tensor factorization.

Embodiments of the present invention are made in view of the above-described problems and an object thereof is to accelerate processing related to non-negative tensor factorization.

### Means for Solving the Problem

In order to attain the object, an embodiment of the present invention provides a tensor data calculation device that includes a matrix product calculation processor and decomposes N-th order (N is an integer of 2 or more) non-negative tensor data into N factor matrices by factorization, the tensor data calculation device including: a factorization means that represents update formulae of the factor matrices for optimizing a prescribed objective function value in a format that includes a matrix product of a first matrix obtained by expanding other N−1 factor matrices other than the factor matrices by a Kronecker product and a second matrix defined by a tensor product of the non-negative tensor data and the N factor matrices and calculate the update formulae; and a matrix calculation means that calculates the matrix products included in the update formulae with the aid of the matrix product calculation processor, wherein the factorization means calculates the update formulae using calculation results of the matrix products calculated by the matrix calculation means.

### Effects of the Invention

Processing related to non-negative tensor factorization can be accelerated.

### BRIEF DESCRIPTION OF DRAWINGS

FIG. 1 is a diagram for describing an example of a configuration of a GPU having a matrix product dedicated processor incorporated therein.

FIG. 2 is a diagram for describing an example of calculation of a matrix product in the matrix product dedicated processor.

FIG. 3 is a diagram illustrating an example of a functional configuration of a tensor data calculation device according to an embodiment of the present invention.

FIG. 4 is a diagram illustrating an example of a hardware configuration of the tensor data calculation device according to an embodiment of the present invention.

FIG. 5 is a first diagram for describing an example of the procedure of an update process.

FIG. 6 is a second diagram for describing an example of the procedure of an update process.

FIG. 7 is a third diagram for describing an example of the procedure of an update process.

FIG. 8 is a fourth diagram for describing an example of the procedure of an update process.

FIG. 9 is a fifth diagram for describing an example of the procedure of an update process.

### DESCRIPTION OF EMBODIMENTS

Hereinafter, embodiments of the present invention will be described. In an embodiment of the present invention, a tensor data calculation device 10 capable of accelerating processing related to non-negative tensor factorization by calculating a matrix product with the aid of a matrix product dedicated processor will be described.

<Configuration of GPU Having Matrix Product Dedicated Processor Incorporated Therein>

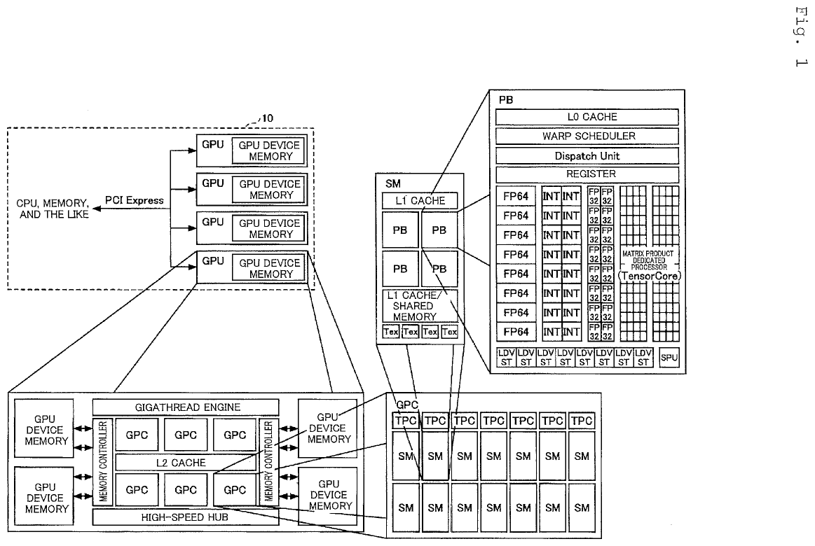

First, a configuration of a GPU having a matrix product dedicated processor incorporated therein will be described with reference to FIG. 1. FIG. 1 is a diagram for describing an example of a configuration of a GPU having a matrix product dedicated processor incorporated therein. In the following description of the embodiments of the present invention, it is assumed that the GPU is a GPU having a matrix product dedicated processor incorporated therein.

As illustrated in FIG. 1, one or more GPUs (in FIG. 1, four GPUs) are mounted in the tensor data calculation device 10 according to the embodiment of the present invention. Each GPU is communicably connected to a CPU, a memory, and the like via a bus such as PCI Express.

Each GPU includes a plurality of GPU processing clusters (GPCs), a plurality of device memories, a memory controller, an L2 cache, a GigaThread engine, and a high-speed hub. Moreover, each GPC includes a plurality of stream multiprocessors (SMs) and a plurality of texture processor clusters (TPCs). Furthermore, each SM includes an L1 cache (or a shared memory) and a plurality of processing blocks (PBs).

Each PB includes various processors including the matrix product dedicated processor as well as an L0 cache, a Warp scheduler, a Dispatch unit, and a register. The various processors include, for example, a processor (FP64) enabling a double-precision (64 bit) floating-point arithmetic operation, a processor (FP32) enabling a single-precision (32 bit) floating-point arithmetic operation, a processor (INT) enabling an integer arithmetic operation and the like. In the example illustrated in FIG. 1, one PB includes two matrix product dedicated processors, and each matrix product dedicated processor includes 4×16 product-sum calculators.

Each PB can perform data communication with the L1 cache of an SM at a high speed and with low latency and realizes high-speed parallel processing using many processors simultaneously while suppressing a communication volume. An example of the matrix product dedicated processor is “TensorCore” and the like incorporated in a GPU of the “Volta”-generation or later which is one of GPU architectures of NVIDIA Corporation.

<Calculation of Matrix Product in Matrix Product Dedicated Processor>

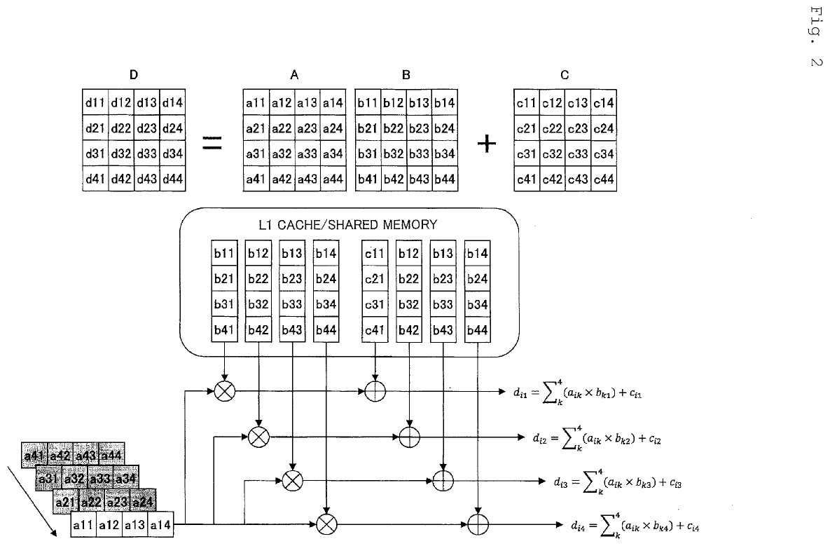

Calculation of a matrix product by the matrix product dedicated processor will be described with reference to FIG. 2. FIG. 2 is a diagram for describing an example of calculation of a matrix product in the matrix product dedicated processor. In FIG. 2, more generally, a case of calculating a matrix product and a matrix sum (that is, a case of calculating D=AB+C where A, B, and C are 4×4 matrices) will be described. When a matrix product only is calculated, it is sufficient to set C=0. When a matrix product larger than 4×4 is handled, a larger matrix product can be calculated by substituting the results of divided calculations into C at any time and integrating the results. The respective elements of A, B, C, and D will be denoted by aᵢⱼ, bᵢⱼ, cᵢⱼ, and dᵢⱼ, respectively.

As illustrated in FIG. 2, a matrix product dedicated processor receives the elements aᵢ₁, aᵢ₂, aᵢ₃, and aᵢ₄ of the i-th row of the matrix A from i=1 to i=4, calculates the product sums of the elements aᵢ₁, aᵢ₂, aᵢ₃, and aᵢ₄ of the i-th row of the matrix A and the elements b₁ⱼ, b₂ⱼ, b₃ⱼ, and b₄ⱼ of the j-th column of the matrix B stored in the L1 cache (or a shared memory) in parallel with respect to j, and adds the element cᵢⱼ of the i-th row and j-th column of the matrix C stored in the L1 cache (or a shared memory) in parallel with respect to j.

As described above, since the matrix product dedicated processor can calculate the respective elements dᵢⱼ of the matrix D with respect to j in parallel in a flow-wise manner, it is possible to calculate the matrix product and the matrix sum D=AB+C efficiently. The matrix product dedicated processor calculating the matrix product and the matrix sum of 4×4 matrices with respect to j in parallel is an example, and the matrix product dedicated processor may be able to calculate the matrix product of matrices having arbitrary numbers of rows and columns in parallel depending on a configuration of a product-sum calculator included in the matrix product dedicated processor.

<Functional Configuration of Tensor Data Calculation Device 10>

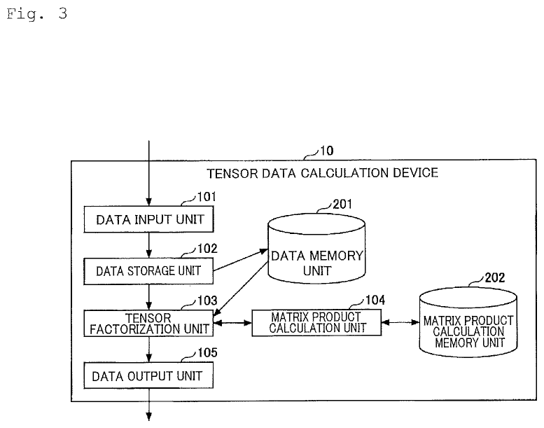

Next, a functional configuration of the tensor data calculation device 10 according to an embodiment of the present invention will be described with reference to FIG. 3. FIG. 3 is a diagram illustrating an example of a functional configuration of the tensor data calculation device 10 according to an embodiment of the present invention.

As illustrated in FIG. 3, the tensor data calculation device 10 according to the embodiment of the present invention includes a data input unit 101, a data storage unit 102, a tensor factorization unit 103, a matrix product calculation unit 104, and a data output unit 105. Among these functional units, for example, the data input unit 101, the data storage unit 102, the tensor factorization unit 103, and the data output unit 105 can be realized by processing that one or more programs installed in the tensor data calculation device 10 causes the CPU to execute. On the other hand, for example, the matrix product calculation unit 104 can be realized by processing that one or more programs installed in the tensor data calculation device 10 causes a CPU and a GPU to execute.

The tensor data calculation device 10 according to an embodiment of the present invention includes a data memory unit 201 and a matrix product calculation memory unit 202. The data memory unit 201 is realized using a storage device such as, for example, an auxiliary storage device. On the other hand, the matrix product calculation memory unit 202 is realized using an L1 cache, a shared memory, or the like of the GPU.

The data input unit 101 inputs data that can be represented as tensors. In this case, the data input unit 101 may input the data by receiving data from other devices and the like via a communication network and may input the data by reading data stored in a storage device such as an auxiliary storage device, for example.

The data storage unit 102 stores the data input by the data input unit 101 in the data memory unit 201 as tensor data. In this way, the tensor data is stored in the data memory unit 201.

The tensor factorization unit 103 performs non-negative tensor factorization with respect to the tensor data stored in the data memory unit 201. In this case, the tensor factorization unit 103 represents the tensor products of the update formulae (for example, expressions (4) to (6)) of the factor matrices as matrix products. The tensor factorization unit 103 requests the matrix product calculation unit 104 to calculate the matrix products of the update formulae of the factor matrices.

The matrix product calculation unit 104 calculates the matrix products using the matrix product calculation memory unit 202 with the aid of the matrix product dedicated processor in response to the request from the tensor factorization unit 103. The matrix product calculation unit 104 returns the calculation results of the matrix products to the tensor factorization unit 103.

The data output unit 105 outputs data indicating the processing results (that is, the factor matrices obtained by non-negative tensor factorization) of the tensor factorization unit 103: In this case, an output destination of the data output unit 105 is not particularly limited. The output destination of the data output unit 105 may be a storage device such as an auxiliary storage device, may be a display device such as a display, and may be a prescribed device connected via a communication network, for example.

<Hardware Configuration of Tensor Data Calculation Device 10>

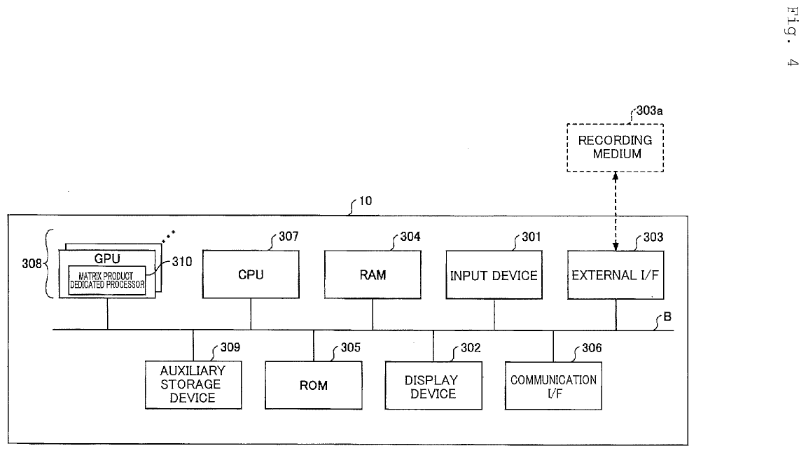

Next, a hardware configuration of the tensor data calculation device 10 according to an embodiment of the present invention will be described with reference to FIG. 4. FIG. 4 is a diagram illustrating an example of a hardware configuration of the tensor data calculation device 10 according to an embodiment of the present invention.

As illustrated in FIG. 4, the tensor data calculation device 10 according to an embodiment of the present invention includes an input device 301, a display device 302, an external I/F 303, a random access memory (RAM) 304, a read only memory (ROM) 305, a communication I/F 306, a CPU 307, one or more GPUs 308, and an auxiliary storage device 309. These hardware components are communicably connected via a bus B.

The input device 301 is a keyboard, a mouse, a touch panel, and the like, for example, and is used for users to input various operations. The display device 302 is a display or the like, for example, and displays the processing results of the tensor data calculation device 10. The tensor data calculation device 10 may not include at least one of the input device 301 and the display device 302.

The external I/F 303 is an interface to an external device. An example of the external device is a recording medium 303a and the like. The tensor data calculation device 10 can read and write data from and to the recording medium 303a or the like via the external I/F 303. One or more programs and the like for realizing the functional units (for example, the data input unit 101, the data storage unit 102, the tensor factorization unit 103, the matrix product calculation unit 104, and the data output unit 105) included in the tensor data calculation device 10 may be recorded on the recording medium 303a.

Examples of the recording medium 303a include a flexible disk, a compact disc (CD), a digital versatile disk (DVD), a secure digital (SD) memory card, a universal serial bus (USB) memory card, and the like.

The RAM 304 is a volatile semiconductor memory that temporarily retains programs and data. The ROM 305 is a nonvolatile semiconductor memory capable of retaining programs and data even if the power is turned off. Setting information related to an operating system (OS), setting information related to a communication network, and the like, for example, are stored in the ROM 305.

The communication I/F 306 is an interface for connecting the tensor data calculation device 10 to a communication network. One or more programs for realizing the functional units of the tensor data calculation device 10 may be acquired (downloaded) from a prescribed server or the like via the communication I/F 306.

The CPU 307 is an arithmetic device that reads programs and data from the ROM 305, the auxiliary storage device 309, and the like onto the RAM 304 and executes various control processes and the like. The GPU 308 is an arithmetic device capable of processing data in parallel. The matrix product dedicated processor 310 specialized for calculation of matrix products is incorporated into the GPU 308. As described above, the matrix product dedicated processor 310 is an arithmetic device capable of calculating matrix products efficiently by processing matrix products of 4×4 matrices in parallel, for example. The functional units of the tensor data calculation device 10 are realized by processing that one or more programs stored in the auxiliary storage device 308, for example, cause the CPU 307 and/or the GPU 308 to execute.

The auxiliary storage device 309 is a hard disk drive (HDD), a solid state drive (SSD), or the like, for example, and is a nonvolatile storage device that stores programs and data. Examples of the programs and data stored in the auxiliary storage device 309 include an OS, an application program, one or more programs and the like for realizing the functional units included in the tensor data calculation device 10.

The tensor data calculation device 10 according to the embodiment of the present invention can realize various processes to be described later due to the hardware configuration illustrated in FIG. 4. Although the example illustrated in FIG. 4 illustrates a hardware configuration when the tensor data calculation device 10 is realized as one computer, the present invention is not limited thereto, but the tensor data calculation device 10 may be realized as a plurality of computers.

<Non-Negative Tensor Factorization>

A case in which the tensor data calculation device 10 according to the embodiment of the present invention performs non-negative tensor factorization will be described. In the following description, a case in which the third-order tensor data X of I×J×K stored in the data memory unit 201 is decomposed into a factor matrix A of I×R, a factor matrix B of J×R, and a factor matrix C of K×R will be described. In this case, the elements xᵢⱼₖ of the matrix X, the elements aᵢᵣ of the matrix A, the elements aⱼᵣ of the matrix B, and the elements cₖᵣ of the matrix C are non-negative values. R is the number of bases of the factor matrices A, B, and C.

In this case, as described above, the tensor data X can be represented as expression (1). When a generalized KL divergence (gKL) distance is used as the distance function L for obtaining the factor matrices A, B, and C, the distance function L (X|\hat{ }X) can be represented as expression (3). In this case, the update formulae of the factor matrices A, B, and C are represented as expressions (4) to (6).

A case in which the tensor products of the update formulae (the update formula of aᵢᵣ, the update formula of bⱼᵣ, and the update formula of cₖᵣ) illustrated in expressions (4) to (6) are represented as matrix products will be described. In the following description, it is assumed that the data input by the data input unit 101 is stored in the data memory unit 201 as the tensor data X by the data storage unit 102.

<<Update formula of a_{ir>>}

First, the denominator of the fractional part of the update formula of aᵢᵣ illustrated in expression (4) can be represented as expression (8) below as a term that depends only on r.

$$\begin{matrix}[ Formula 6 ] & \\ {Q}_{r} = \frac{1}{{\sum }_{j}^{J} {\sum }_{k}^{K} {b}_{jr} {c}_{kr}} = \frac{1}{{\sum }_{j}^{J} {b}_{jr} {\sum }_{k}^{K} {c}_{kr}} & ( 8 )\end{matrix}$$

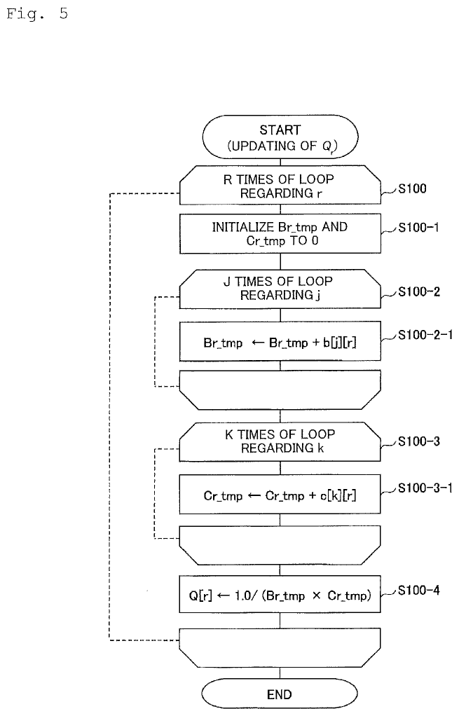

Qᵣ can be calculated in advance by the update process illustrated in FIG. 5. FIG. 5 is a first diagram for describing an example of the procedure of the update process. In the following description, it is assumed that Q[r] is an array element that stores Qᵣ, Br_tmp and Cr_tmp are variables that temporarily store calculation results, b[j][r] is an array element that stores the elements bar of the factor matrix B, and c[k][r] is an array element that stores the elements cₖᵣ of the factor matrix C.

As illustrated in FIG. 5, the tensor factorization unit 103 executes initialization (S100-1) of Br_tmp and Cr_tmp to 0 for each r, J times of loop processing (S100-2) regarding j, K times of loop processing (S100-3) regarding k, and calculation processing (S100-4) of Q[r]←1.0/(Br_tmp×Cr_tmp) within R times of loop processing (S100) regarding r. Here, “←” represents substituting the calculation result on the right side into the left side.

The tensor factorization unit 103 executes calculation processing (S100-2-1) of Br_tmp←Br_tmp+b[j] [r] for each j within J times of loop processing regarding j. Similarly, the tensor factorization unit 103 executes calculation processing (S100-3-1) of Cr_tmp←Cr_tmp+c[k][r] for each k within K times of loop processing regarding k.

In this way, the denominator Qᵣ of the update formula of aᵢᵣ illustrated in expression (4) is calculated as a term that depends only on r. As described above, Qᵣ can be calculated in advance before aᵢⱼ is actually updated by the update formula of expression (4).

Subsequently, the numerator of the fractional part of the update formula of aᵢᵣ illustrated in expression (4) can be expressed as a matrix product of two matrices Wand Z. Specifically, it is assumed that when W is a P×R non-negative matrix (where P=J×K) represented as the following expression, and the elements wₚᵣ of the matrix W is represented as the product wₚᵣ=bⱼᵣ×cₖᵣ of the element bⱼᵣ of the factor matrix B and the element cₖᵣ of the factor matrix C. This means the factor matrix B and the factor matrix C are expanded by a Kronecker product. Here, p=j×K+k.

[Formula 7]

W=[wₚᵣ]∈ [symbol] ₊^{P×R}

However, p=j×K+k is based on the assumption that the possible values of the variable j are j=0, . . . , J−1. For example, p=(j−1)×K+k when the possible values of the variable j are j=1, . . . , J.

Using the matrix W, \hat{ }xᵢⱼₖ can be represented as expression (9) below.

$$\begin{matrix}[ Formula 8 ] & \\ {\hat{x}}_{ijk} = {\{ {AW}^{t} \}}_{ip} = {\sum }_{r}^{R} {a}_{ir} {w}_{pr} & ( 9 )\end{matrix}$$

Here, t represents transposition. Moreover, {AW^{t}}ᵢₚ is the (i,p) element of a matrix product AW^{t}. Since p can be represented by j and k, the matrix product AW^{t} can be calculated indirectly. Although a transposition matrix of W is represented as Wt in expression (9), when the matrix product dedicated processor 310 calculates a matrix product, it may be preferable to calculate a matrix product AW′ using W^{t} as another matrix W′=W^{t} due to the format of a data structure.

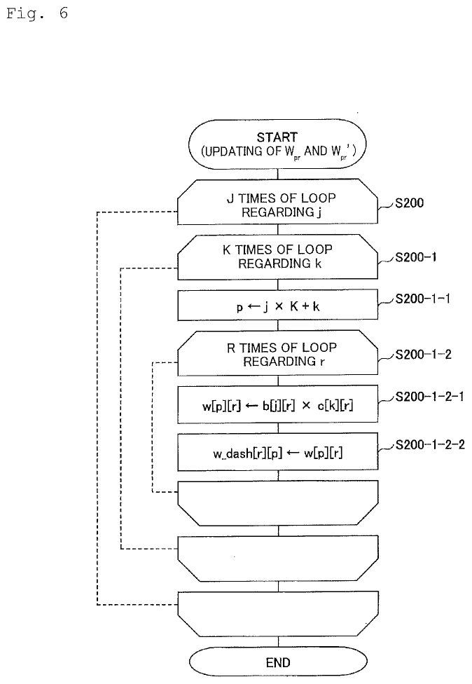

These matrices W and W′=W^{t} can be calculated by the update process illustrated in FIG. 6. FIG. 6 is a second diagram for describing the procedure of the update process. In the following description, it is assumed that w[p][r] is an array element that stores wₚᵣ of the matrix W and w_dash [r][p] is an array element that stores the elements wᵣₚ′ of the matrix W′=W^{t}.

As illustrated in FIG. 6, the tensor factorization unit 103 executes K times of loop processing (S200-1) regarding k for each j within J times of loop processing (S200) regarding j. Moreover, the tensor factorization unit 103 executes calculation processing (S200-1-1) of p←j×K+k for each k and executes R times of loop processing (S200-1-2) regarding r within K times of loop processing regarding k. Furthermore, the tensor factorization unit 103 executes calculation processing (S200-1-2-1) of w[p][r]←b[j][r]×c[k][r] for each r and executes calculation processing (S200-1-2-2) of w_dash[r][p]←w[p][r] within R times of loop processing regarding r.

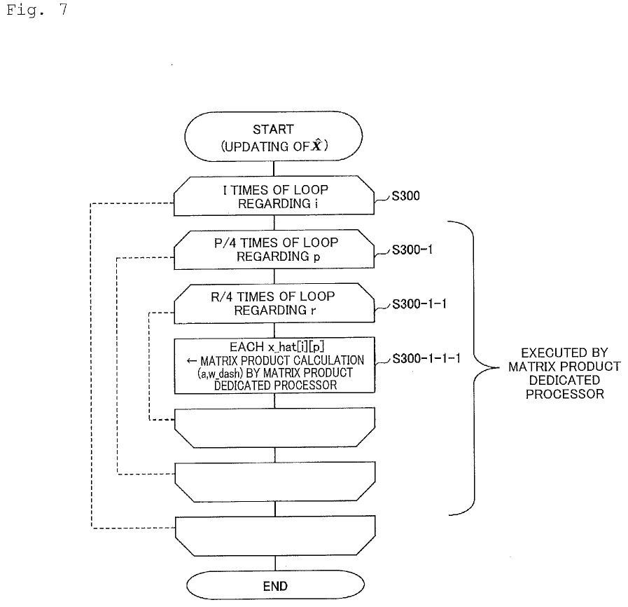

The elements \hat{ }xᵢⱼₖ={AW^{t}}ᵢₚ of \hat{ }X can be calculated by the update process illustrated in FIG. 7 after W′ is calculated in the update process illustrated in FIG. 6. FIG. 7 is a third diagram for describing an example of the procedure of the update process. In the following description, it is assumed that x_hat[i][p] is an array element that stores the elements \hat{ }xᵢⱼₖ of \hat{ }X. \hat{ }xᵢⱼₖ may be stored in a three-dimensional array using the array element that stores the elements \hat{ }xᵢⱼₖ of \hat{ }X as x_hat [i][j][k]. However, it may be preferable to store the same in a two-dimensional array in order to directly store the calculation results of the matrix product dedicated processor 310.

As illustrated in FIG. 7, the tensor factorization unit 103 executes I times of loop processing (S300) regarding i. In this case, the tensor factorization unit 103 requests the matrix product calculation unit 104 to calculate a matrix product for each i within I times of loop processing regarding i.

When calculation of a matrix product is requested, the matrix product calculation unit 104 executes P/4 times of loop processing (S300-1) regarding p. Moreover, the matrix product calculation unit 104 executes R/4 times of loop processing (S300-1-1) regarding r for each p within P/4 times of loop processing regarding p. Furthermore, the matrix product calculation unit 104 executes calculation processing (S300-1-1-1) of x_hat[i][p] (matrix product calculation (a,w_dash) by the matrix product dedicated processor 310) for each r within R/4 times of loop processing regarding r.

In this case, the right side of the calculation processing of step S300-1-1 represents calculating a matrix product of a 4×4 matrix Aᵢᵣ corresponding to the number of loops regarding r and the number of loops regarding i and a 4×4 matrix Wᵣₚ′ corresponding to the number of loops regarding r and the number of loops regarding p when the matrices A and W′ are divided into 4×4 matrices. The array elements a[i][r] of Aᵢᵣ are certain sixteen array elements among the array elements a[i][r] of A. Similarly, the array elements w_dash[r][p] of Wᵣₚ′ are certain sixteen array elements of the array elements w_dash[r][p] of W′.

The left side of the calculation processing of step S300-1-1 represents the array element x_hat[i][p] of a 4×4 matrix \hat{ }Xᵣₚ corresponding to the number of loops regarding r and the number of loops regarding p. The array elements x_hat[i][p] of \hat{ }Xᵣₚ are certain sixteen elements of the array elements x_hat[i][p] of \hat{ }X.

In this way, the matrix product calculation unit 104 calculates the array element \hat{ }xᵢⱼₖ (that is, the (i,p) element of the matrix product AW′) of \hat{ }X for each 4×4 matrix with the aid of the matrix product dedicated processor 310. In this case, for example, the matrix product calculation unit 104 stores the array element w_dash [r] [p] in the matrix product calculation memory unit 202 and calculates the matrix product AW′ by calculating the product sum of the sixteen array elements a[i][r] and the sixteen array elements w_dash[r] [p] in parallel for each 4×4 matrix as described in FIG. 2. Although the number of loops regarding p is P/4 and the number of loops regarding r is R/4, this is because the matrix product dedicated processor 310 according to the embodiment of the present invention calculates the matrix product of 4×4 matrices simultaneously (that is, the matrix product is calculated by dividing the calculation into (P×R)/16 times). Generally, for example, when the matrix product dedicated processor 310 can calculate the matrix product of M×M matrices simultaneously, it is sufficient that the number of loops regarding p is set to P/M and the number of loops regarding r is set to R/M.

The tensor factorization unit 103 can request the matrix product calculation unit 104 to calculate the matrix product AW′ by calling a cublasGemmEx( ) function or the like, for example. When the numbers of rows and columns of the matrices A and W′ are not multiples of 4, the rows and columns may be padded with 0 appropriately.

When Z is given as a non-negative matrix of I×P as follows,

[Formula 9]

Z=[zᵢₚ]∈ [symbol] ₊^{I×P}

the elements zᵢₚ of Z are represented as follows.

$${z}_{ip} = \frac{{x}_{ijk}}{{\hat{x}}_{ijk}} \qquad [ Formula 10 ]$$

By doing so, the update formula aᵢᵣ illustrated in expression (4) can be represented as expression (10) below.

[Formula 11]

aᵢᵣ:=aᵢᵣQᵣ{ZB}ᵢᵣ (10)

Here, {ZW}ᵢᵣ is the (i,r) element of the matrix product ZW and the matrix product can be calculated as follows.

$${\{ ZW \}}_{ir} = {\sum }_{p}^{P} {z}_{ip} {w}_{pr} \qquad [ Formula 12 ]$$

Therefore, finally, by calculating the matrix product with the aid of the matrix product dedicated processor 310, it is possible to accelerate processing related to non-negative tensor factorization.

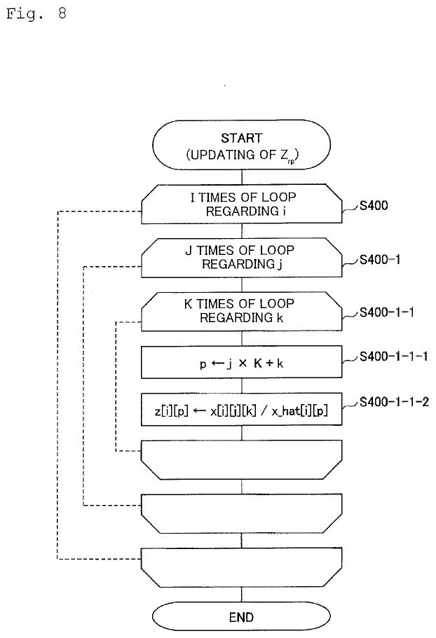

The elements zᵢₚ of Z can be calculated by the update process illustrated in FIG. 8 after \hat{ }X is calculated by the update process illustrated in FIG. 7. FIG. 8 is a fourth diagram for describing an example of the procedure of the update process. In the following description, it is assumed that Z[i][p] is an array element that stores the elements zᵢₚ of Z and x[i][j][k] is an array element that stores the elements xᵢⱼₖ of X.

As illustrated in FIG. 8, the tensor factorization unit 103 executes loop processing (S400-1) regarding j for each i within I times of loop processing (S400) regarding i. Moreover, the tensor factorization unit 103 executes K times of loop processing (S400-1-1) regarding k for each j within loop processing regarding j. Furthermore, the tensor factorization unit 103 executes, calculation processing of p←j×K+k for each k and executes calculation processing (S400-1-2) of z[i][p]←x[i][j][k]/x_hat [i][p] within K times of loop processing (S400-1-2) regarding k.

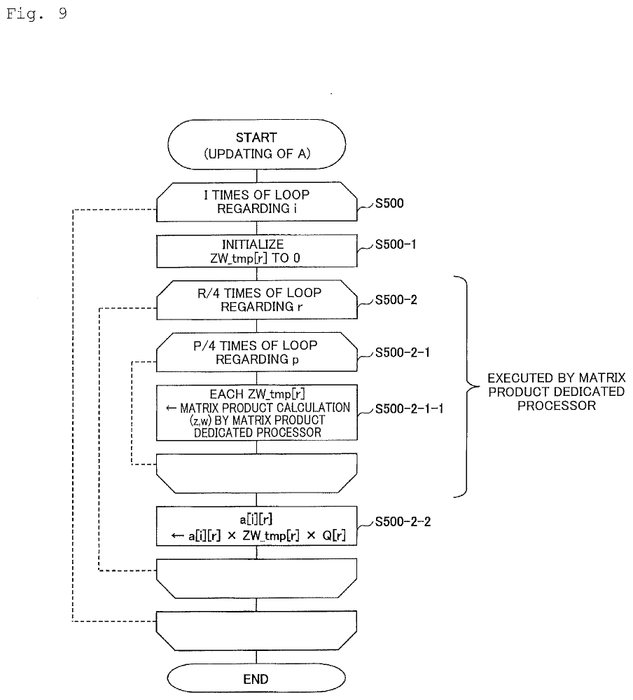

The elements aᵢᵣ of the factor matrix A can be updated by the update process illustrated in FIG. 9 after Z is calculated by the update process illustrated in FIG. 8 (that is, the elements aᵢᵣ can be updated by expression (10)). FIG. 9 is a fifth diagram for describing an example of the procedure of the update process. In the following description, it is assumed that ZW_tmp is an array that temporarily stores the calculation results and ZW_tmp[r] is an array element of this array.

As illustrated in FIG. 9, the tensor factorization unit 103 executes I times of loop processing (S500) regarding i. Moreover, the tensor factorization unit 103 performs initialization (S500-1) of ZW_tmp[r] to 0 for each i and requests the matrix product calculation unit 104 to calculate a matrix product.

When calculation of the matrix product is requested, the matrix product calculation unit 104 executes R/4 times of loop processing (S500-2) regarding r. Moreover, the matrix product calculation unit 104 executes P/4 times of loop processing (S500-2-1) regarding p for each r within R/4 times of loop processing regarding r. Furthermore, the matrix product calculation unit 104 executes calculation processing (S500-2-1-1) of each ZW_tmp[r]←(matrix product calculation (z,w) by the matrix product dedicated processor 310) for each p within P/4 times of loop processing regarding p.

The matrix product calculation unit 104 executes calculation processing (S500-2-2) of a[i][r]←a[i][r]×ZW_tmp [r]×Q[r] after P/4 times of loop processing regarding p is executed by the matrix product calculation unit 104. In this way, the array elements a[i][r] of the factor matrix A are updated.

In this case, the right side of the calculation processing of step S500-2-1-1 represents calculating a matrix product of a 4×4 matrix Zᵢₚ corresponding to the number of loops regarding p and the number of loops regarding i and a 4×4 matrix Wₚᵣ corresponding to the number of loops regarding p and the number of loops regarding r when the matrices Z and W are divided into 4×4 matrices. The array elements z[i][p] of Zᵢₚ are certain sixteen array elements among the array elements z[i][p] of Z. Similarly, the array elements w[p][r] of Wₚᵣ are certain sixteen array elements of the array elements w[p] [r] of W.

The left side of the calculation processing of step S500-2-1-1 represents the array elements ZW_tmp[r] of a matrix product ZᵢₚWₚᵣ of the 4×4 matrix Zᵢₚ and the 4×4 matrix Wₚᵣ.

In this way, the matrix product calculation unit 104 calculates the matrix product ZW for each 4×4 matrix with the aid of the matrix product dedicated processor 310. In this case, for example, the matrix product calculation unit 104 stores the array element w[p][r] in the matrix product calculation memory unit 202 and calculates the matrix product ZW by calculating the product sum of the sixteen array elements z[i][p] and the sixteen array elements w[p][r] in parallel for each 4×4 matrix as described in FIG. 2. Although the number of loops regarding p is P/4 and the number of loops regarding r is R/4, this is because the matrix product dedicated processor 310 according to the embodiment of the present invention calculates the matrix product of 4×4 matrices simultaneously (that is, the matrix product is calculated by dividing the calculation into (P×R)/16 times). Generally, for example, when the matrix product dedicated processor 310 can calculate the matrix product of M×M matrices simultaneously, it is sufficient that the number of loops regarding p is set to P/M and the number of loops regarding r is set to R/M.

As described above, the tensor factorization unit 103 can request the matrix product calculation unit 104 to calculate the matrix product AW′ by calling a cublasGemmEx( ) function or the like, for example. When the numbers of rows and columns of the matrices A and W′ are not multiples of 4, the rows and columns may be padded with 0 appropriately.

<<Update Formula of b_{jr>>}

In the update formula of bⱼᵣ illustrated in expression (5), the symbols in the description of the update formula of aᵢᵣ may be read as follows.

aᵢᵣ→bⱼᵣ

bⱼᵣ→aᵢᵣ

sum Σ up to J with respect to j→sum Σ up to I with respect to i

P=J×K→P=I×K

p=j×K+k→p=i×K+k

{AW^{t}}ᵢₚ→{BW^{t}}ⱼₚ

zᵢₚ→zⱼₚ (that is, Z is read as J×P matrix)

{ZW}ᵢᵣ→{ZW}ⱼᵣ

In this way, the update formula of bⱼᵣ illustrated in expression (5) can be represented as a matrix product of bⱼᵣ:=bⱼᵣQᵣ{ZW}ⱼᵣ.

<<Update Formula of c_{kr>>}

In the update formula of cₖᵣ illustrated in expression (6), the symbols in the description of the update formula of aᵢᵣ may be read as follows.

aᵢᵣ→cₖᵣ

cₖᵣ→aᵢᵣ

sum Σ up to K with respect to k→sum Σ up to I with respect to i

P=J×K→P=J×I

p=j×K+k→p=j×I+i

{AW^{t}}ᵢₚ→{CW^{t}}ₖₚ

zᵢₚ→zₖₚ (that is, Z is read as K×P matrix)

{ZW}→{ZW}ₖᵣ

In this way, the update formula of cₖᵣ illustrated in expression (6) can be represented as a matrix product of cₖᵣ:=cₖᵣQᵣ{ZW}ₖᵣ.

As described above, the tensor data calculation device 10 according to the embodiment of the present invention can represent the update formulae of the factor matrices A, B, and C of third-order non-negative tensor data X as matrix products when the tensor data X is factorized. The tensor data calculation device 10 according to the embodiment of the present invention calculates the matrix product with the aid of the matrix product dedicated processor 310. In this way, the tensor data calculation device 10 according to the embodiment of the present invention can execute processing related to non-negative tensor factorization at a high speed. The processing results (that is, the data indicating the factor matrices A, B, and C obtained finally) of the non-negative tensor factorization is output to a prescribed output destination by the data output unit 105.

<Case of Second-Order Tensors>

While a case of factorizing third-order non-negative tensor data X has been described, the embodiment of the present invention can be applied similarly to factorization of second-order tensors (that is, matrices). In the following description, tensor factorization (that is, matrix factorization of non-negative matrix data X) of second-order non-negative tensor data X will be described.

Tensor factorization of second-order non-negative tensor data X can be represented as expression (11) below using factor matrices A and B.

[Formula 13]

X≃\hat{X}=AB (11)

In this case, the update formula of aᵢᵣ is represented as expression (12) below, for example.

$$\begin{matrix}[ Formula 14 ] & \\ {a}_{ir} := {a}_{ir} \times \frac{{\sum }_{j}^{J} \frac{{x}_{ij}}{{\hat{x}}_{ij}} {b}_{jr}}{{\sum }_{j}^{J} {b}_{jr}} & ( 12 )\end{matrix}$$

In this case, the elements \hat{ }xᵢⱼ of \hat{ }X is given as follows and \hat{ }X can be represented as a matrix product AB^{t}.

$${\hat{x}}_{ij} = {\sum }_{r}^{R} {a}_{ir} {b}_{jr} \qquad [ Formula 15 ]$$

Therefore, \hat{ }X can be calculated by the matrix product dedicated processor 310.

Similarly to the case of third-order tensors, the matrix Z is represented as follows.

$${z}_{ij} = \frac{{x}_{ij}}{{\hat{x}}_{ij}} \qquad [ Formula 16 ]$$

Similarly, Qᵣ is also represented as follows.

$${Q}_{r} = \frac{1}{{\sum }_{j}^{J} {b}_{jr}} \qquad [ Formula 17 ]$$

In this way, the update formula of aᵢᵣ can be represented as expression (13) below.

[Formula 18]

aᵢᵣ:=aᵢᵣQᵣ{ZB}ᵢᵣ (13)

Therefore, by causing the matrix product dedicated processor 310 to calculate the matrix products included in the update formulae, it is also possible to accelerate the processing related to non-negative tensor factorization of second-order tensors. The update formula of bⱼᵣ can be represented as a matrix product by reading the same similarly to the case of third-order tensors.

<Case of Higher-Order Tensors>

The embodiment of the present invention can be applied similarly to a case of factorizing higher-order non-negative tensor data X. In the following description, tensor factorization of N-th order (N≥4) non-negative tensor data X will be described.

As illustrated in expression (14) below, tensor factorization of N-th order tensor data in Formula 19 is a method of obtaining N factor matrices in Formula 21 so that \hat{ }X in Formula 20 can reproduce X (that is, X and \hat{ }X are approximately the same).

[Formula 19]

X=[xᵢ_{₁}_{,i}_{₂}_{, . . . ,i}_{_{N}}]∈ [symbol] ₊^{I}^{₁}^{×I}^{₂}^{× . . . ×I}^{_{N}}

[Formula 20]

\hat{X}=[\hat{x}ᵢ_{₁}_{,i}_{₂}_{, . . . ,i}_{_{N}}]∈ [symbol] ₊^{I}^{₁}^{×I}^{₂}^{× . . . ×I}^{_{N}}

[Formula 21]

Yₙ={yᵢ_{ₙ}_{,r}∈ [symbol] ₊^{I}^{ₙ}^{×R}|n=1, . . . ,N}

[Formula 22]

X≈\hat{X}=Y₁∘Y₂∘ . . . ∘Y_{N} (14)

In this case, the tensor product \hat{ }X in expression (14) can be represented as expression (15) below.

$$\begin{matrix}[ Formula 23 ] & \\ {\hat{x}}_{{i}_{1} , {i}_{2}} , … , {i}_{n} = {\sum }_{r}^{R} {y}_{{i}_{1} , r} {y}_{{i}_{2} , r} … {y}_{{i}_{N} , r} & ( 15 )\end{matrix}$$

In this case, when a generalized KL divergence (gKL) distance is used as the distance function L, the following update formula is represented as expression (16) below.

$$\begin{matrix}{y}_{{i}_{n} , r} & [ Formula 24 ] \\ [ Formula 25 ] & \\ {y}_{{i}_{n} , r} := {y}_{{i}_{n} , r} \frac{\begin{matrix}{\sum }_{{i}_{n + 1}}^{{I}_{n + 1}} … {\sum }_{{i}_{N}}^{{I}_{N}} {\sum }_{{i}_{1}}^{{I}_{1}} … {\sum }_{{i}_{n - 1}}^{{I}_{n - 1}} \frac{{x}_{{i}_{1} , … , {i}_{N}}}{{\hat{x}}_{{i}_{1} , … {i}_{N}}} \\ {y}_{{i}_{n + 1} , r} … {y}_{{i}_{N} , r} {y}_{{i}_{1} , r} … {y}_{{i}_{n - 1} , r}\end{matrix}}{\begin{matrix}{\sum }_{{i}_{n + 1}}^{{I}_{n + 1}} … {\sum }_{{i}_{N}}^{{I}_{N}} {\sum }_{{i}_{1}}^{{I}_{1}} … \\ {\sum }_{{i}_{n - 1}}^{{I}_{n - 1}} {y}_{{i}_{n + 1} , r} … {y}_{{i}_{N} , r} {y}_{{i}_{1} , r} … {y}_{{i}_{n - 1} , r}\end{matrix}} & ( 16 )\end{matrix}$$

This update formula can be represented as a matrix product similarly to the cases of second-order and third-order tensors.

First, the denominator of the fractional part of the update formula illustrated in expression (16) can be represented as expression (17) below as a term that depends only on r.

$$\begin{matrix}[ Formula 26 ] & \\ {Q}_{r} = \frac{1}{{\sum }_{{i}_{n + 1}}^{{I}_{n + 1}} {y}_{{i}_{n + 1} , r} … {\sum }_{{i}_{N}}^{{I}_{N}} {y}_{{i}_{N} , r} {\sum }_{{i}_{1}}^{{I}_{1}} {y}_{{i}_{1} , r} … {\sum }_{{i}_{n - 1}}^{{I}_{n - 1}} {y}_{{i}_{n - 1} , r}} & ( 17 )\end{matrix}$$

Subsequently, the numerator of the fractional part of the update formula illustrated in expression (16) can be expressed as a matrix product of two matrices W⁽ⁿ⁾ and Z⁽ⁿ⁾. Specifically, W⁽ⁿ⁾ is given as follows as a P⁽ⁿ⁾×R non-negative matrix (where P⁽ⁿ⁾=Iₙ× . . . ×I_{N}×I₁× . . . ×Iₙ₋₁).

[Formula 27]

W⁽ⁿ⁾=[wₚᵣ⁽ⁿ⁾]∈ [symbol] ₊^{p(n)×R}

In this case, the elements of W⁽ⁿ⁾ are represented as the product of the elements of a matrix Yₙ.

[Formula 28]

wₚᵣ⁽ⁿ⁾=yᵢ_{ₙ₊₁}_{,r} . . . yᵢ_{_{N}}_{,r}yᵢ_{₁}_{,r} . . . yᵢ_{_{n−1}}_{,r}

This means expanding the factor matrices Yₙ₊₁, . . . , Y_{N}, Y₁, . . . , Yₙ₋₁ by a Kronecker product. Here, p is given as follows.

[Formula 29]

p=(((((iₙ₊₁Iₙ₊₂+iₙ₊₂) . . . )I_{N}+i_{N})I₁+i₁) . . . )Iₙ₋₁+iₙ₋₁

Using the matrix W⁽ⁿ⁾, the elements of \hat{ }X can be represented as expression (18) below.

$$\begin{matrix}[ Formula 30 ] & \\ {\hat{x}}_{{i}_{1} , … {i}_{n}} = {\{ {Y}_{n} {W}^{( n ) τ} \}}_{{i}_{n} p} = {\sum }_{r}^{R} {y}_{{i}_{n} , r} {w}_{pr}^{( n )} & ( 18 )\end{matrix}$$

The (iₙ,p) elements of the matrix product Yₙ W^{(n)t} are given as follows, and the matrix product can be calculated indirectly using p.

[Formula 31]

{YₙW^{(n)T}}ᵢ_{ₙ}_{,p}

Subsequently, similarly to the cases of second-order and third-order tensors, when the matrix Z⁽ⁿ⁾ in Formula 32 is given, the elements thereof are represented as in Formula 33.

$$\begin{matrix}{Z}^{( n )} = [ {z}_{{i}_{n} , p}^{( n )} ] ∈ {ℝ}_{+}^{{I}_{n} \times {P}^{( n )}} & [ Formula 32 ] \\ {z}_{{i}_{n} , p}^{( n )} = \frac{{x}_{{i}_{1 , … , {i}_{N}}}}{{\hat{x}}_{{i}_{1 , … , {i}_{N}}}} & [ Formula 33 ]\end{matrix}$$

In this way, the update formula illustrated in expression (16) can be represented as expression (19) below.

[Formula 34]

yᵢ_{ₙ}_{,r}:=yᵢ_{ₙ}_{,r}Qᵣ{Z⁽ⁿ⁾W⁽ⁿ⁾}ᵢ_{ₙ}_{,r} (19)

Here, the (iₙ, r) elements of the matrix product Z⁽ⁿ⁾W⁽ⁿ⁾ are given as in Formula 35 and the matrix product can be calculated as in Formula 36.

$$\begin{matrix}\{ {Z}^{( n )} {W}^{( n )} \} {i}_{n} , r & [ Formula 35 ] \\ \{ {Z}^{( n )} {W}^{( n )} \} {i}_{n} , r = {\sum }_{p}^{p ( n )} {z}_{{i}_{n , p}}^{( n )} {w}_{pr}^{( n )} & [ Formula 36 ]\end{matrix}$$

Therefore, finally, by causing the matrix product dedicated processor 310 to calculate the matrix product, it is also possible to accelerate the processing related to non-negative tensor factorization of N-th order tensors.

### Summary

As described above, the tensor data calculation device 10 according to the embodiment of the present invention can represent the update formulae of factor matrices of non-negative tensor data X as matrix products when the tensor data X is factorized. That is, the tensor data calculation device 10 according to the embodiment of the present invention enables the update formulae of the factor matrices to be represented as matrix products by expanding the factor matrices by a Kronecker product.

In this way, the tensor data calculation device 10 according to the embodiment of the present invention can calculate matrix products with the aid of the matrix product dedicated processor 310 and execute processing related to non-negative tensor factorization at a high speed.

The embodiment of the present invention may be combined with the method disclosed in Japanese Patent Application Publication No. 2016-139391. In this case, it is possible to suppress decrease in processing speed due to random access to memory and to accelerate processing related to the non-negative tensor factorization.

The present invention is not limited to the embodiment disclosed specifically, and various modifications and changes can be made without departing from the spirit of the claims.

### REFERENCE SIGNS LIST

10 Tensor data calculation device
101 Data input unit
102 Data storage unit
103 Tensor factorization unit
104 Matrix product calculation unit
105 Data output unit
201 Data memory unit
202 Matrix product calculation memory unit

1. A tensor data calculation device that decomposes N-th order (N is an integer of 2 or more) non-negative tensor data into N factor matrices by factorization, the tensor data calculation device comprising:
a processor;
a matrix product calculation processor; and
a memory storing program instructions that cause the processor to represent update formulae of the factor matrices for optimizing a prescribed objective function value in a format that includes a matrix product of a first matrix obtained by expanding other N−1 factor matrices other than each of the factor matrices by a Kronecker product and a second matrix defined by a tensor product of the non-negative tensor data and the N factor matrices and calculate the update formulae; and that cause the matrix product calculation processor to calculate the matrix products included in the update formulae, wherein the processor calculates the update formulae using calculation results of the matrix products calculated by the matrix product calculation processor.

2. The tensor data calculation device according to claim 1, wherein the non-negative tensor data is data indicating third-order tensors of I×J×K, and the second matrix is a matrix of which the (i,p) element is a quotient of an (i,j,k) element of the non-negative tensor data and an (i,j,k) element of a tensor product of the N factor matrices, where p=j×K+k (where j is an integer of 1≤1≤J and k is 1≤k≤K).

3. The tensor data calculation device according to claim 2, wherein the factor matrices include an I×R factor matrix A, a J×R factor matrix B, and a K×R factor matrix C, and the first matrix that defines a matrix product included in the update formula of the factor matrix A is a matrix of which the (p,r) element is bⱼᵣ×cₖᵣ where r (1≤r≤R) is a variable representing the number of bases R of the factorization, bⱼᵣ is the elements of the factor matrix B, and cₖᵣ is the elements of the factor matrix C.

4. The tensor data calculation device according to claim 1, wherein the processor calculates a prescribed term of the update formula as a term that depends only on a variable representing the number of bases of the factorization.

5. A tensor data calculation method performed by a tensor data calculation device that includes a matrix product calculation processor and decomposes N-th order (N is an integer of 2 or more) non-negative tensor data into N factor matrices by factorization, the tensor data calculation method comprising:
representing update formulae of the factor matrices for optimizing a prescribed objective function value in a format that includes a matrix product of a first matrix obtained by expanding other N−1 factor matrices other than each of the factor matrices by a Kronecker product and a second matrix defined by a tensor product of the non-negative tensor data and the N factor matrices and calculating the update formulae; and
calculating the matrix products included in the update formulae with the aid of the matrix product calculation processor,
wherein the calculating of the update formulae uses calculation results of the matrix products calculated in the calculating of the matrix products.

6. A non-transitory computer-readable recording medium having stored therein a program comprising the program instructions for causing a computer to function as the tensor data calculation device according to claim 1.
